(19) United States
(12) Patent Application Publication
(10) Pub. No.: US 2015/0016212 A1
(43) Pub. Date: Jan. 15, 2015

(54) RETRACTABLE MIXING DEVICE AND METHOD

(71) Applicant: SPX CORPORATION, Charlotte, NC (US)

(72) Inventors: Andrew Creathorn, Penfield, NY (US); Bernd Gigas, Rochester, NY (US); Michael McCarroll, West Henrietta, NY (US)

(21) Appl. No.: 14/331,824

(22) Filed: Jul. 15, 2014

Related U.S. Application Data
(60) Provisional application No. 61/846,264, filed on Jul. 15, 2013.

(51) Int. Cl. B01F 7/00

(52) U.S. Cl. CPC B01F 7/00233
USPC 366/194; 366/279

(57) ABSTRACT

A system for mixing a fluid in a tank includes a mixer assembly, a housing, and an actuator. The mixer assembly has a motor, a shaft, and an impeller. The housing is disposed in a side wall of the tank. The housing has sufficient volume to contain the impeller. The actuator is configured to retract the mixer assembly and draw the impeller into the housing. The mixer assembly has a first conformation and a second conformation. In the first conformation the impeller is disposed in a main portion of the tank and configured to mix the fluid in response to rotation of the impeller via the motor and shaft. In the second conformation the impeller is disposed in the housing and out of the main portion of the tank.

### CROSS-REFERENCE TO RELATED APPLICATIONS

This application claims priority to U.S. provisional application entitled, RETRACTABLE MIXING DEVICE AND METHOD, filed Jul. 15, 2013, having Ser. No. 61/846,264, the disclosure of which in hereby incorporated by reference in its entirety.

### FIELD OF THE INVENTION

The present invention generally relates to a mixing device and method. More particularly, the present invention pertains to a device and method for mixing a fluid disposed in a tank.

### BACKGROUND OF THE INVENTION

It is generally known that fluids stored in tanks will often settle. Settling of some fluid may be of no consequence or even desirable. However, in other fluid, settling may be detrimental. For example, in petroleum product, settling may cause basic components to precipitate or concentrate at or near the bottom of the tank—damaging the tank and reducing the quality of the petroleum product stored therein. In general, this problem is referred to as basic sediment and water (BS&W).

Gasoline and crude oil storage tanks are generally agitated for product blending, uniformity and suspension of sediment and water. Since this type of storage vessel is typically very large diameter with relatively short height, top entry agitators are generally not practical and side entry agitators are used.

Side entry agitators penetrate through the side wall of the vessel and project several feet into the tank. There is currently no provision to extract the shaft and impeller from the tank without breaking the vessel seal which could result in a substantial spillage from the vessel.

Environmental requirements for gasoline tanks in particular have shifted the tank designs to use floating roofs. This allows for the minimization of the vapor space above the fluid and hence volatilization. Due to the presence of the current design side entry agitators, floating roofs cannot be dropped to the bottom of the vessel and a significant perpetual inventory must be maintained in each tank.

Accordingly, it is desirable to provide a system, device and method capable of overcoming the disadvantages described herein at least to some extent.

### SUMMARY OF THE INVENTION

The foregoing needs are met, to a great extent, by the present invention, wherein various respects a system, device, and method of mixing fluid in a tank is provided.

An embodiment of the present invention pertains to a system for mixing a fluid in a tank. The system includes a mixer assembly, a housing, and an actuator. The mixer assembly has a motor, a shaft, and an impeller. The housing is disposed in a side wall of the tank. The housing has sufficient volume to contain the impeller. The actuator is configured to retract the mixer assembly and draw the impeller into the housing. The mixer assembly has a first conformation and a second conformation. In the first conformation the impeller is disposed in a main portion of the tank and configured to mix the fluid in response to rotation of the impeller via the motor and shaft. In the second conformation the impeller is disposed in the housing and out of the main portion of the tank.

Another embodiment of the present invention relates to a mixer assembly. The mixer assembly includes an impeller, a motor to rotate the impeller, and a shaft affixed to the impeller and convey torque from the motor to the impeller. The mixer assembly additionally includes housing having sufficient volume to contain the impeller, a seal, and an actuator. The seal is disposed in the housing. The seal is configured to facilitate rotation of the shaft and being configured to facilitate longitudinal sliding the shaft while reducing leakage of a fluid across the seal. The actuator is configured to urge the shaft to move longitudinally. The impeller is drawn into the housing in response to the actuator moving the shaft.

Yet another embodiment of the present invention pertains to a method of drawing a fluid from a tank having a floating roof. In this method, if it is determined the roof is below a predetermined minimum level an impeller is retracted from the tank and into a chamber affixed to a side of the tank. In this manner, additional fluid may be drawn from the tank and the roof is allowed to descend below the impeller in response to the impeller being in the housing and out of a main portion of the tank.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a simplified cross sectional view of a tank mixing system in a first conformation according to an embodiment of the invention.

FIG. 2 is a simplified cross sectional view of the tank mixing system in a second conformation according to the embodiment FIG. 1.

FIG. 3 is a cross sectional view of a first example of the tank mixing system in the first conformation according to the embodiment of FIG. 1.

FIG. 4 is a cross sectional view of the first example of the tank mixing system in the second conformation according to the embodiment of FIG. 1.

FIG. 5 is a perspective view of the first example of the tank mixing system in the first conformation according to the embodiment of FIG. 1.

FIG. 6 is a perspective view of the first example of the tank mixing system in the second conformation according to the embodiment of FIG. 1.

FIG. 7 is a cross sectional view of a second example of the tank mixing system in the first conformation according to the embodiment of FIG. 1.

FIG. 8 is a cross sectional view of the second example of the tank mixing system in the second conformation according to the embodiment of FIG. 1.

FIG. 9 is a perspective view of the second example of the tank mixing system in the first conformation according to the embodiment of FIG. 1.

FIG. 10 is a perspective view of the second example of the tank mixing system in the second conformation according to the embodiment of FIG. 1.

FIG. 11 is a cross sectional view of a third example of the tank mixing system in the first conformation according to the embodiment of FIG. 1.

FIG. 12 is a cross sectional view of the third example of the tank mixing system in the second conformation according to the embodiment of FIG. 1.

FIG. 13 is a perspective view of the third example of the tank mixing system in the first conformation according to the embodiment of FIG. 1.

FIG. 14 is a perspective view of the third example of the tank mixing system in the second conformation according to the embodiment of FIG. 1.

### DETAILED DESCRIPTION

The present invention provides a retractable impeller for a tank mixing system and method of retracting an impeller from a tank. For the purposes of this disclosure, the term “tank” and variations thereof refer to a container or vessel of any suitable size or shape and to contain any suitable fluid. In a particular example, the tank or tanks described herein may be suitable for containing many tens, hundreds, thousands, millions etc. of liters of fluid. In a specific example, the fluid may be a petroleum product stored in a tank having a relatively large volume such as, hundreds to millions of barrels.

FIG. 1 is a simplified cross sectional view of a tank mixing system 10 in a first conformation according to an embodiment of the invention. As shown in FIG. 1, the tank mixing system 10 includes a tank 12 and impeller assembly 14. The tank 12 is configured to contain a suitable fluid 16. Suitable examples of the fluid 16 include petroleum based fluid such as oil and fuel and any fluid subject to separation. The tank 12 includes a side wall 18 and a roof 20. In a particular example, the roof 20 is configured to float or otherwise blanket the fluid 16.

The impeller assembly 14 is configured to mix or otherwise generate a flow of the fluid 16 in the tank 12 to prevent or reduce separation of components within the fluid 16. In general, the impeller assembly 14 includes an impeller 22, shaft 24, seal 26, housing 28, motor 30 and support 32. As shown herein, various examples of seals, housings, and supports are envisioned in this or other embodiments of the invention. The impeller 22 is configured to urge the fluid 16 to flow in response the being rotated. The shaft 24 is configured to transfer torque from the motor 30 to the impeller 22. The seal 26 is configured to prevent or reduce leakage of the fluid 16 around the shaft 24. In addition, the seal 26 is configured to facilitate retracting the shaft 24 from the tank 12 and inserting the shaft into the tank 12. As shown herein, the seal 26 may include one seal or a plurality of seals operable to facilitate sliding the impeller assembly 14 and rotation of the shaft 24.

The housing 28 is configured to provide a recess or chamber of sufficient volume for the impeller 22 and/or at least a portion of the shaft 24 to be retracted from a main volume of the tank 12 and allow the roof 20 to descend below the level of the impeller 22. The motor 30 is configured to generate sufficient torque to rotate the impeller 22 via the shaft 24. In general, the motor 30 may include any suitable motor or actuator such as, for example, electric, pneumatic, hydraulic, combustion driven, and the like. The support 32 is configured to support the motor 30 and/or reduce lateral forces on the shaft 24 and/or the seal 26. Optionally, the support 32 is configured to facilitate refraction and/or insertion of the impeller assembly 14.

In addition, the tank mixing system 10 optionally includes an actuator 34, sensor 36, and/or controller 38. If included, the actuator 34 may be configured to draw the shaft 24 and impeller 22 into the housing 28 and/or urge the shaft 24 and impeller 22 out of the housing 28 and back into the tank 12. In various examples, the actuator 34 may include a hydraulic or pneumatic actuator, threaded rod and follower, geared rack and pinion, or other such linear actuator. The sensor 36 may include any suitable sensor such as, for example, a pressure transducer, electrical resistance, or the like. The controller 38 may be configured to receive signals from the sensor 36 and/or a user. The controller 38 may be further configured to send and/or receive signals from the actuator 34 to modulate the actuator 34 and/or monitor the actuator 34 for position, resistance to movement, etc. The control of retraction and/or insertion may be manual and/or automatic. For example, a user may utilize the controller 38 to modulate the actuator 34. In addition or alternatively, the controller 38 may automatically send signals to the actuator 34 in response to signals from the sensor 36. In this manner, the impeller 22 may automatically be drawn into the housing 28 in response to the roof 20 falling below a predetermined minimum level and/or the impeller 22 may automatically be inserted into the tank 12 from the housing 28 in response to the roof 20 rising above the predetermined minimum level.

Alternatively or in addition, the level of the roof 20 may be determined by monitoring an amount of the fluid 16 in the tank 12. For example, based on an amount of the fluid placed 16 in the tank 12 verses an amount of the fluid 16 drawn from the tank 12, an amount of the fluid 16 currently remaining in the tank 12 can be estimated. If is determined the level of the fluid 16 is below the predetermined minimum, the impeller 22 may be retracted into the housing 28 either manually or automatically.

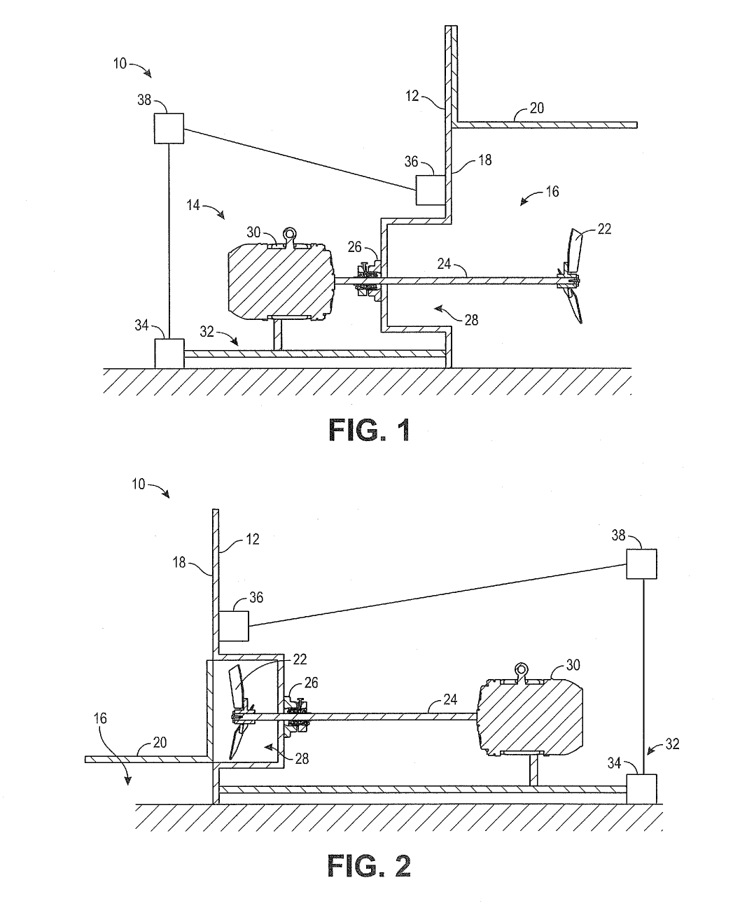

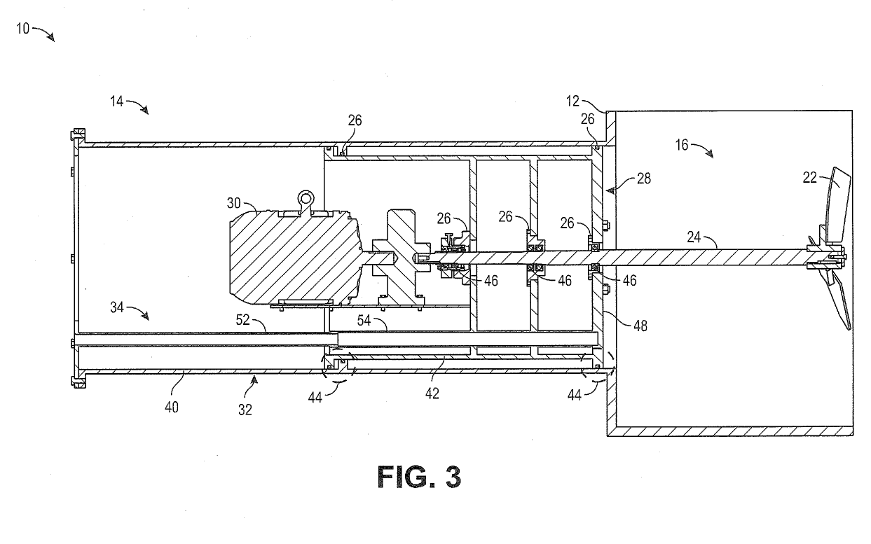

FIG. 2 is a simplified cross sectional view of the tank mixing system 10 in a second conformation according to the embodiment FIG. 1. As shown in FIG. 2, the roof 20 is operable to descend in response to the fluid 16 being withdrawn from the tank 12. In order to allow the roof 20 to fully descend and/or avoid being struck by the impeller 22, the impeller 22 is retracted into the housing 28. In the following FIGS. 3-14, various examples of the tank mixing system are shown.

FIG. 3 is a cross sectional view of a first example of the tank mixing system 10 in the first conformation according to the embodiment of FIG. 1. As shown in FIG. 3, the impeller assembly 14 is essentially housed in the support 32. The support 32 includes a housing 40 that may be generally cylindrical in shape. The motor 30 and shaft 24 are disposed within a sled 42. The seal 26 include seals 44 that are operable to facilitate the sled 42 sliding within the housing 40. The seal 26 further includes shaft seals 46 configured to facilitate rotation of the shaft 24 within the sled 42. The housing 28 is defined by an inner wall 48 of the sled 42 and the housing 40. As such, in this first conformation, the housing 28 has a relatively low volume.

To urge the sled 42 to slide relative to the housing 40, the impeller assembly 14 may include the actuator 34. The actuator 34 may include any suitable device operable to urge the sled 42 to move relative to the housing 40. Examples of suitable actuators include hydraulic cylinders, screw drives, and the like. In a particular example, the actuator 34 includes a hydraulic cylinder with a piston 52 configured to mate with a cylinder 54 and driven by a hydraulic fluid in a generally understood manner.

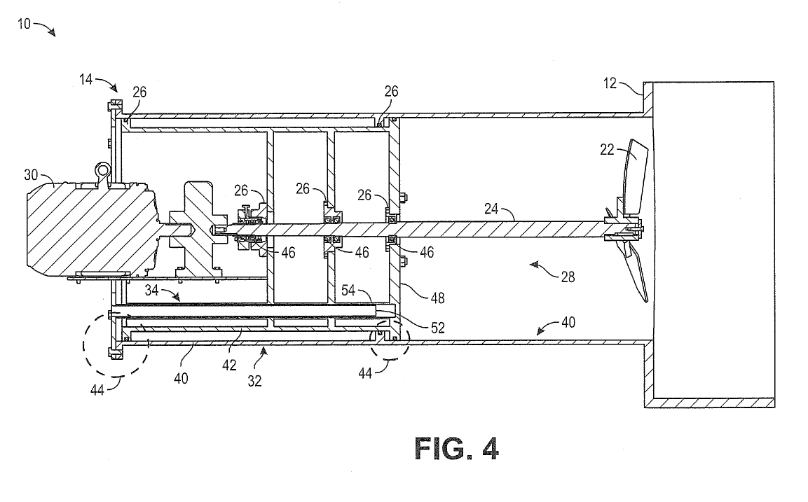

FIG. 4 is a cross sectional view of the first example of the tank mixing system 10 in the second conformation according to the embodiment of FIG. 1. As shown in FIG. 4, the sled 42 has slid relative to the housing 40 to retract the impeller 22 from the tank 12. For example, in response to the actuator 34 drawing the piston 52 into the cylinder 54, the sled 42 has been urged to slide within the housing 40. The housing 28 has increased in volume in response to the distal movement of the sled 42 within the housing 40.

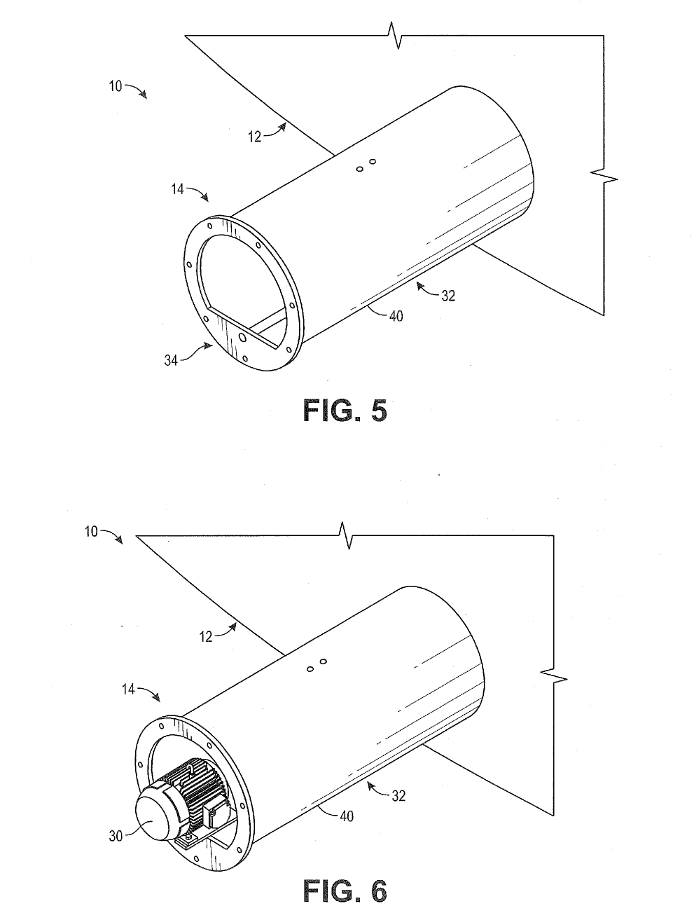

FIGS. 5 and 6 are perspective views of the first example of the tank mixing system 10 in the first and second conformation according to the embodiment of FIG. 1. As shown in FIG. 5, the impeller assembly 14 is essentially housed in the support 32. In this manner, the impeller assembly 14 may be protected to some extent. As shown in FIG. 6, the motor 30 may extend somewhat from the housing 40 for servicing, for example.

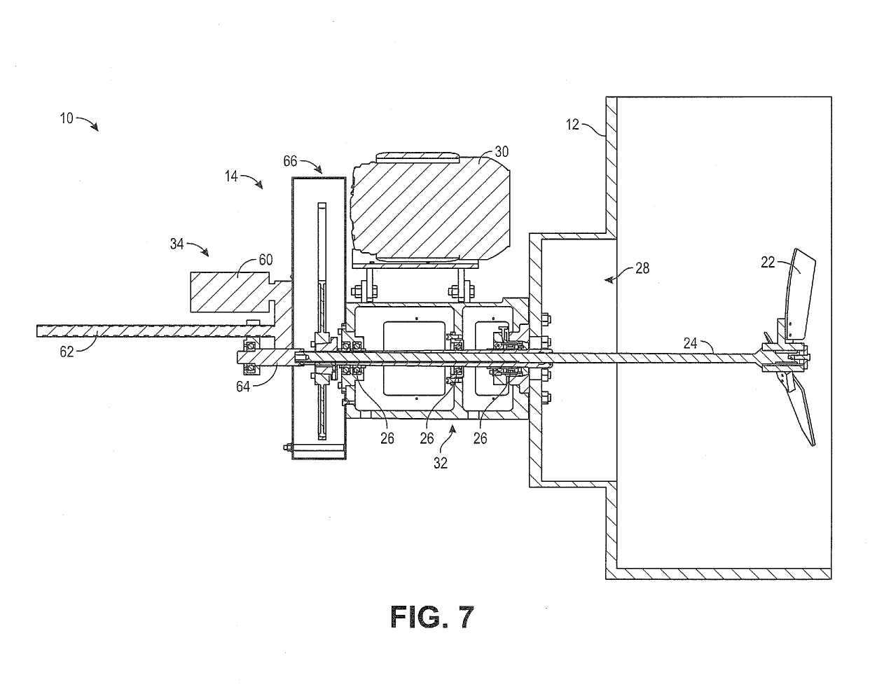

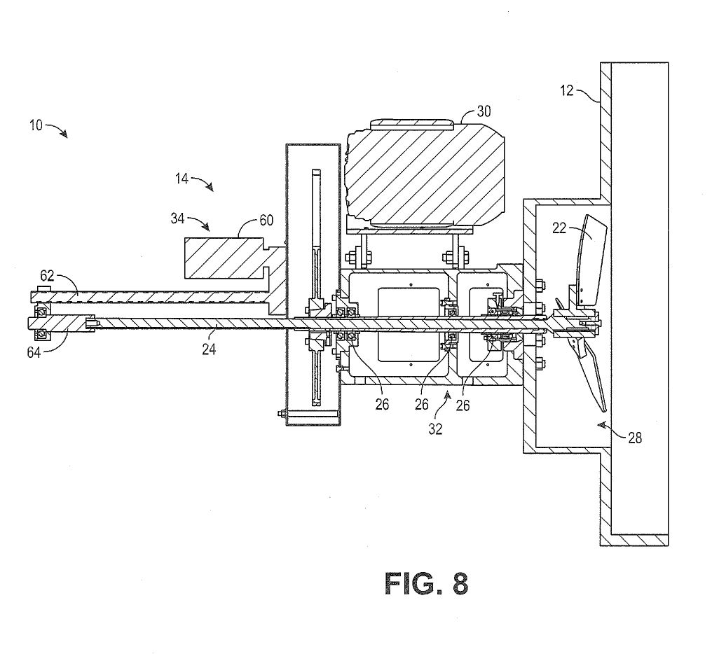

FIG. 7 is a cross sectional view of a second example of the tank mixing system 10 in the first conformation according to the embodiment of FIG. 1. As shown in FIG. 7 the shaft 24 is configured to slide and rotate within the support 32. The support 32 includes the seal 26 and the motor 30 is disposed upon the support 32. The actuator 34 includes a motor 60 to rotate a threaded rod 62. A follower 64 disposed at the distal end of the shaft 24 is configured to translate along the threaded rod 62 in response to rotation of the threaded rod 62. A belt and pulley system 66 may be configured to transfer torque from the motor 30 to the shaft 24. As shown in FIGS. 7 and 8, the shaft 24 includes a sliding relationship with the belt and pulley system 66 while also being in a fixed rotational relationship with the belt and pulley system 66.

FIG. 8 is a cross sectional view of the second example of the tank mixing system 10 in the second conformation according to the embodiment of FIG. 1. As shown in FIG. 8, the follower 64 is urged along the threaded rod 62 in response to rotation of the threaded rod 62. In this manner, the impeller 22 is drawn into the housing 28.

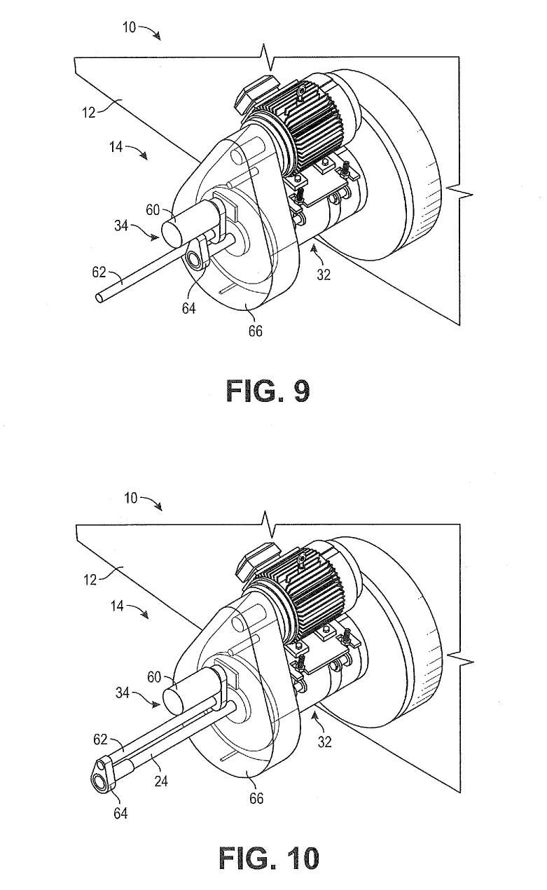

FIGS. 9 and 10 are perspective views of the second example of the tank mixing system 10 in the first and second conformation according to the embodiment of FIG. 1. As shown in FIG. 9, the follower 64 is proximal to the tank 12. In FIG. 10, rotation of the threaded rod 62 has drawn the follower 64 and shaft 24 away from the tank 12 which, in turn, has drawn the impeller 22 into the housing 28. In this manner, the impeller 22 may be drawn into the housing 28 to avoid coming in contact with the roof 20 as the level of the fluid 16 falls in the tank 12.

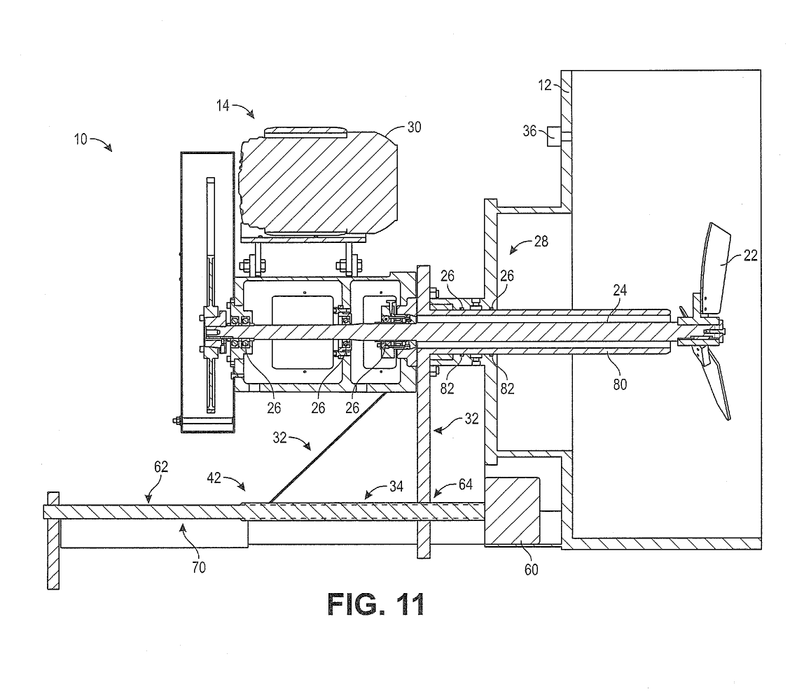

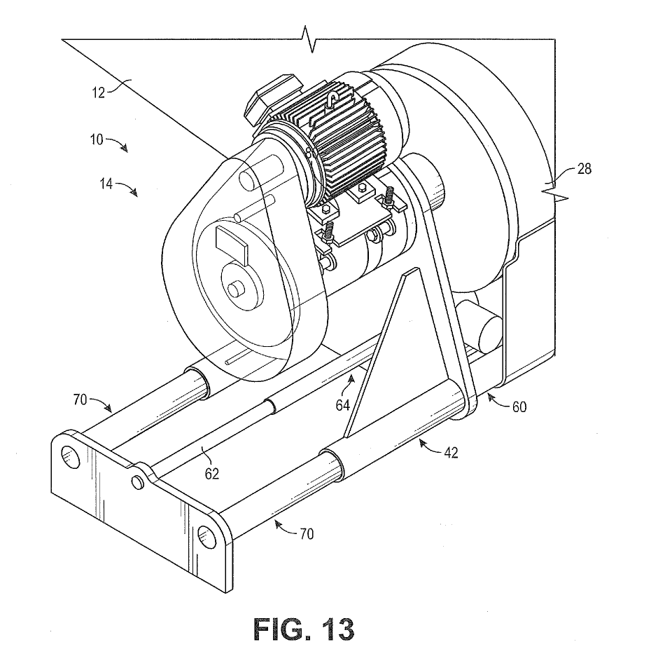

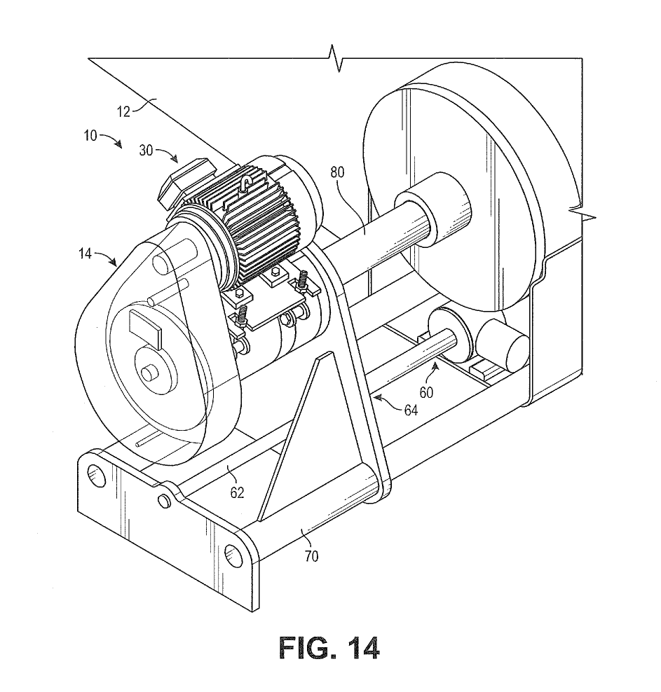

FIG. 11 is a cross sectional view of a third example of the tank mixing system 10 in the first conformation according to the embodiment of FIG. 1. As shown in FIG. 11, the impeller assembly 14 is mounted on the sled 42. The sled 42 is configured to ride on one or more rails 70. The actuator 34 is more clearly shown in FIGS. 13 and 14 and includes the motor 60, threaded rod 62, and follower 64 configured to retract and/or insert the impeller assembly 14. In addition, the impeller assembly 14 includes a sleeve 80 in sliding engagement with one or more sleeve seals 82. It is an advantage of this example that the sleeve seals 82 are only subject to sliding engagement.

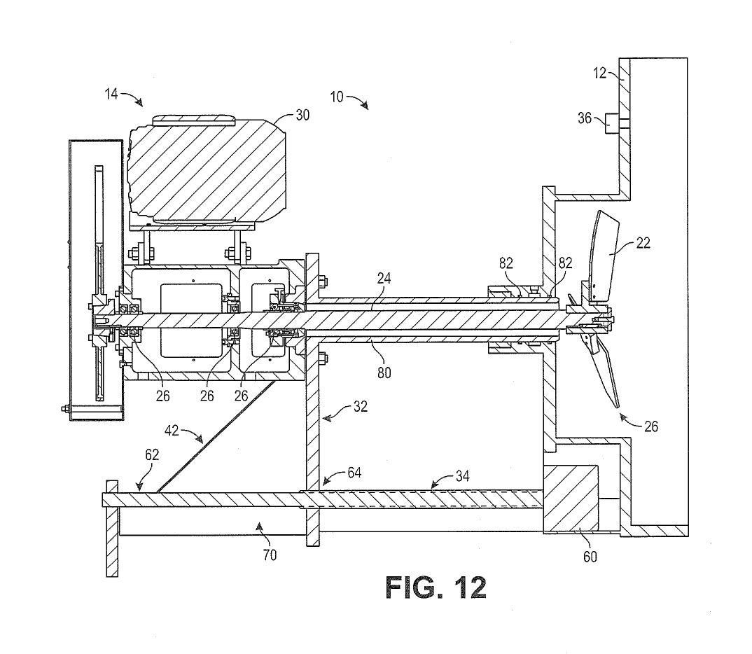

FIG. 12 is a cross sectional view of the third example of the tank mixing system 10 in the second conformation according to the embodiment of FIG. 1. As shown in FIG. 12, the impeller assembly 14 is drawn away from the tank 12 via the movement of the sled 42. The sleeve 80 and sleeve seals 82 are configured to facilitate the movement of the shaft 24 out of and into the tank 12 with little or no loss of the fluid 16. In this manner, the impeller 22 may be drawn into the housing 28 to avoid coming in contact with the roof 20 as the level of the fluid 16 falls in the tank 12.

FIGS. 13 and 14 are perspective views of the third example of the tank mixing system 10 in the first and second conformation according to the embodiment of FIG. 1. As shown in FIG. 13, in a particular example, the sled 42 is configured to ride on a pair of rails 70. Also shown is the threaded rod 62 is disposed between the pair of rails 70. The follower 64 is affixed to the sled 42 and rotation of the threaded rod 62 urges the sled 42 to move. In FIG. 14, the sleeve 80 is shown drawn from the tank 12. In this second conformation, the impeller 22 is drawn into the housing 28 and out of the way of the roof 20.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A system for mixing a fluid in a tank, the system comprising:
a mixer assembly having a motor, a shaft, and an impeller;
a housing disposed in a side wall of the tank, the housing having sufficient volume to contain the impeller; and
an actuator configured to retract the shaft and draw the impeller into the housing, wherein the shaft is slidingly engaged to an opening in the housing and has a first conformation and a second conformation, in the first conformation the impeller is disposed in a main portion of the tank and configured to mix the fluid in response to rotation of the impeller via the motor and shaft, in the second conformation the impeller is disposed in the housing and out of the main portion of the tank.

2. The system according to claim 1, further comprising:
a pulley in a fixed rotational relation relationship to the shaft while facilitating a sliding relationship along the shaft.

3. The system according to claim 2, further comprising:
a threaded rod disposed in alignment with the shaft and configured to be rotated by the actuator, wherein shaft is urged to slide relative to the pulley and relative to the housing in response to rotation of the threaded rod.

4. The system according to claim 3, further comprising:
a follower configured to engage the threaded rod and an end of the shaft, wherein as the follower is drawn along the threaded rod in response to rotation of the threaded rod, the follower is configured to urge the end of the shaft to follow.

5. The system according to claim 1, further comprising:
a support fixed to the housing and configured to support the mixer assembly.

6. The system according to claim 5, further comprising:
a seal disposed within the opening in the housing and configured to prevent leakage of the fluid from the tank as the shaft slides therethrough.

7. The system according to claim 1, further comprising:
a controller configured to control the actuator.

8. The system according to claim 7, further comprising:
a sensor, the sensor configured to sense a roof of the tank and the sensor being configured to forward a signal to the controller, wherein the controller is configured to control the actuator to draw the impeller into the housing in response to the roof being sensed by the sensor.

9. A mixer assembly comprising:
an impeller;
a motor to rotate the impeller;
a shaft affixed to the impeller and convey torque from the motor to the impeller;
a housing having sufficient volume to contain the impeller;
a seal disposed in the housing, the first seal being configured to facilitate longitudinal sliding the shaft and rotation of the shaft relative to the housing while reducing leakage of a fluid across the seal;
a pulley in a fixed rotational relation relationship to the shaft while facilitating a sliding relationship along the shaft; and
an actuator configured to urge the shaft to move longitudinally, wherein the impeller is drawn into the housing in response to the actuator moving the shaft.

10. The mixer assembly according to claim 9, further comprising:
a threaded rod disposed in alignment with the shaft and configured to be rotated by the actuator, wherein shaft is urged to slide relative to the pulley and relative to the housing in response to rotation of the threaded rod.

11. The mixer assembly according to claim 10, further comprising:
a follower configured to engage the threaded rod and an end of the shaft, wherein as the follower is drawn along the threaded rod in response to rotation of the threaded rod, the follower is configured to urge the end of the shaft to follow.

12. The mixer assembly according to claim 9, further comprising:
a support fixed to the housing and configured to support the mixer assembly.

13. The mixer assembly according to claim 9, further comprising:
a controller configured to control the actuator.

14. The mixer assembly according to claim 13, further comprising:
a sensor, the sensor configured to sense a roof of the tank is below a predetermined minimum level and the sensor being configured to forward a signal to the controller, wherein the controller is configured to control the actuator to draw the impeller into the housing in response to the roof being sensed by the sensor.

15. The mixer assembly according to claim 14, wherein the controller is configured to urge the impeller back into the tank from the housing in response to the sensor sensing the of the tank is above the predetermined minimum level.

16. A method of drawing a fluid from a tank having a floating roof, the method comprising the steps of:
determining if the roof is below a predetermined minimum level;
retracting an impeller from the tank and into a housing affixed to a side of the tank in response to the roof being below the predetermined minimum level;
drawing additional fluid from the tank, wherein the roof is allowed to descend below the impeller in response to the impeller being in the housing and out of a main portion of the tank.

17. The method according to claim 16, further comprising the step of:
rotating a threaded rod to retract the impeller from the tank.

18. The method according to claim 17, further comprising the step of:
controlling an actuator to rotate the threaded rod with a controller.

19. The method according to claim 18, further comprising the step of:
sensing the roof is below the predetermined minimum level with a sensor and forwarding a signal to the controller.

20. The method according to claim 16, further comprising the step of:
sliding a shaft through a pulley in a fixed rotational relationship to the pulley in response to retracting the impeller.
